(19) United States
(12) Patent Application Publication
(10) Pub. No.: US 2014/0029878 A1
(43) Pub. Date: Jan. 30, 2014

(54) PARTIAL ARC HYDROSTATIC BEARING

(71) Applicants: Anthony R. Wong, Somerville, MA (US); Alexander H. Slocum, Bow, NH (US)

(72) Inventors: Anthony R. Wong, Somerville, MA (US); Alexander H. Slocum, Bow, NH (US)

(73) Assignee: Massachusetts Institute of Technology, Cambridge, MA (US)

(21) Appl. No.: 13/953,089

(22) Filed: Jul. 29, 2013

Related U.S. Application Data
(60) Provisional application No. 61/676,388, filed on Jul. 27, 2012.

(51) Int. Cl. F16C 32/06

(52) U.S. Cl. CPC F16C 32/0629
USPC 384/114

(57) ABSTRACT

A hydrostatic bearing is provided that includes a plurality of bearing pads that form loading carrying areas. A plurality of compensators are coupled to the bearing pads, each compensator includes a recessed region forming a partial arc that partially surrounds an inlet hole, the bearing pads and compensators form self-compensating features positioned on the same side of a shaft that is conducive to hydrodynamic operations

### PRIORITY INFORMATION

This application claims priority from provisional application Ser. No. 61/676,388 filed Jul. 27, 2012, which is incorporated herein by reference in its entirety.

### SPONSORSHIP INFORMATION

This invention was made with government support under Contract No. NO0178-04-D-4066 awarded, by the U.S. Navy. The government has certain rights in the invention.

### BACKGROUND OF THE INVENTION

The invention is related to the field of hydrostatic bearing, and in particular to a partial arc hydrostatic bearing.

Hydrostatic hearings appear in the literature as early as 1851. The basic idea of a hydrostatic bearing is to pressurize a fluid to produce a fluid film between two surfaces which move relative to each other. The fluid film thickness is larger than the surface roughness, so the two surfaces never contact during motion. Additionally, because of the external fluid pressurization, the supporting force is independent of surface speed. This insensitivity to relative surface speed differentiates a hydrostatic bearing from a hydrodynamic bearing. Hydrodynamic journal bearings rely on the shaft speed to generate the fluid film and forces to support the shaft.

In hydrostatic journal bearings, fluid routings connect load bearing features, or bearing pads, to a compensator that regulates the fluid flow to the bearing pads and ensures a pressure differential between opposed load bearing areas, so that the bearing will apply a force to counteract external loads applied to the shaft. A variety of compensation methods exist such as fixed compensation which utilizes a fixed fluid resistance device such as a capillary tube or orifice. Constant flow compensation can be achieved by using separate pumps for each bearing pad or special valves. This work is primarily focused on self-compensation which uses the gap between the surfaces of the bearing and the shaft as a variable restrictor to control flow. Self-compensation has the advantage that no tuning is required like fixed compensation. Also self-compensation is resistant to clogging compared to other methods that involve small fluid openings.

Another hydrostatic bearing development of note which involved placement of all fluid routings on the surface of the bearing or shaft. They called it “surface self-compensation” and had the unique feature that since all the hydraulic logic and connections were on the surface, the motion of the shaft and fluid shear cleans the surface features and thus it is extremely resistant to clogging. In typical hydrostatic bearings, complex fluid routings move fluid from a compensator to the opposed bearing pad. These routings increase complexity and increase the susceptibility of plugging and fouling.

### SUMMARY OF THE INVENTION

According to one aspect of the invention, there is provided a hydrostatic bearing. The hydrostatic bearing includes a plurality of bearing pads that form load carrying areas. A plurality of compensators are coupled to the bearing pads, each compensator includes a recessed region forming a partial arc that partially surrounds an inlet hole, the bearing pads and compensators form self-compensating features positioned on the same side of a shaft that is conducive to hydrodynamic operations.

### BRIEF DESCRIPTION OF THE DRAWINGS

FIG. 1 is a schematic diagram illustrating the inventive hydrostatic bearing flat pattern;

FIG. 2 is schematic diagram illustrating the inventive hydrostatic bearing in its formed state;

FIG. 3 is a schematic diagram illustrating a hyrdrostatic bearing in a test setup;

FIG. 4 is a graph illustrating the comparison of calculated and measured loads;

FIG. 5 is a graph illustrating the comparison of calculated and measured stiffness;

FIG. 6 is a graph illustrating load carrying efficiency;

FIG. 7 is a graph of the compensator used in the inventive hydrostatic bearing;

FIG. 8 is a graph illustrating load sensitivity to additional compensators;

FIG. 9 is a graph illustrating flow sensitivity to additional compensator; and

FIG. 10 is a graph illustrating bearing performance sensitivity to resistance ratio.

### DETAILED DESCRIPTION OF THE INVENTION

The invention involves the design of a self-compensating hydrostatic hearing made from two halves so it can be assembled about a shaft, and the bearing surfaces are made from plastic or rubber bonded to half shell structures. The bearing bore structure can have a precision shape but rough surface finish, or the bearing bore can be as-cast and then the bearing surface vacuum-held by a master cylinder can be bonded in place. The bearing geometry can be molded into the bearing surface, so the entire system can be made for low cost.

The invention uses self-compensating features that are unique in that they are not located on opposite sides of the shaft, yet the initial design has an efficiency of 23%; hence the load capacity can be calculated by multiplying the efficiency by the projected area and the supply pressure, or 0.23×Length×Diameter×Supply Pressure. The bearing can be run with any type of fluid including water. In addition, the new self-compensating features are conducive to hydrodynamic operation when the shaft speed is sufficient; thus pump power can be greatly reduced once a minimum shaft speed is attained. Tests on a 100 mm diameter shaft confirm the design theory.

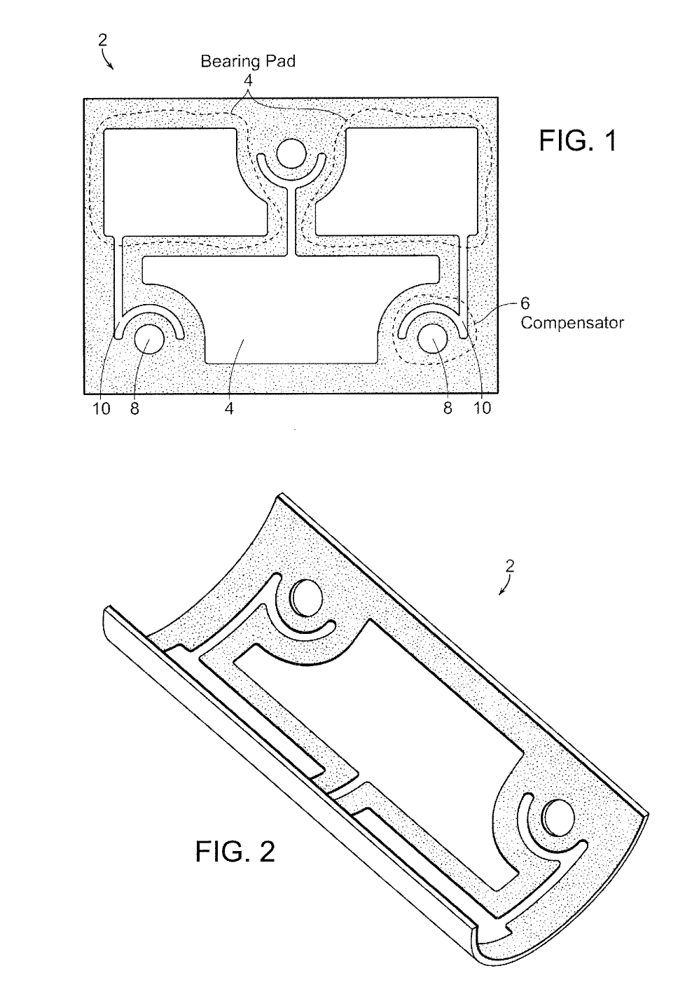

FIG. 1 shows a hydrostatic bearing flat pattern 2 used in accordance with the invention. The hydrostatic bearing includes bearing pads 4 and compensators 6. Hydrostatic bearings are usually comprised of load carrying areas called bearing pads 4. Bearing pads 4 are recess areas surrounded by raised lands forming load carrying areas. The pressure in the bearing pad 4 is proportional to the clearance at the corresponding compensator, i.e., as the shaft moves closer to the compensator, the gap decreases, and the pressure at the corresponding bearing pad decreases. This relationship allows the bearing to resist external loads.

Each compensator 6 includes an inlet hole 8 that is connected to a pressure source. The inlet is surround by a recessed circular region 10 forming a partial arc. The recessed regions 10 are the grooved recessed areas surrounded by raised lands and are coupled to nearby bearing pads 4. The groove depth was selected to be 10 times deeper than the nominal bearing gap. The nominal bearing gap is the clearance between the shaft and the bearing when centered, the radius of the bearing minus the radius of the shaft. The bearing gap is the distance from a particular point on the bearing to the nearest point on the shaft. Since the resistance is inversely proportional to the gap cubed, the resistance in the grooves would be 1000 times less than the raised areas. This low resistance allows the grooves to be treated as constant pressure nodes

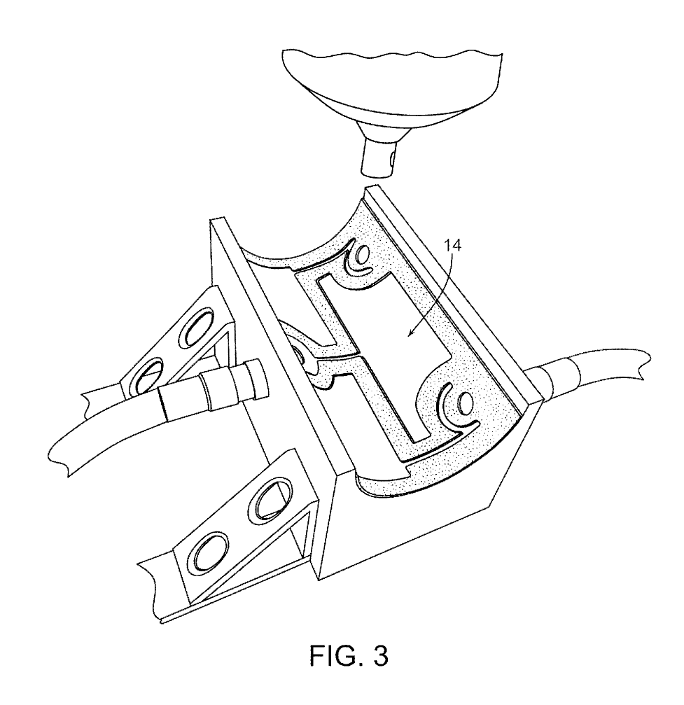

FIG. 2 shows how the bearing would look when rolled into its final state. This flat pattern 2 is designed to cover a 165° arc as opposed to a full 360° journal bearing. The bearing is designed for a shaft that is nominally 100 mm in diameter and has three pocket regions to give the system some tilt stiffness. The dimensions were sized so that the bearing length is roughly twice the diameter. All the fluid routing aside from the fluid inlets is accomplished by the surface features. The lack of additional hoses and orifices increases robustness against plugging and biofouling and allows water to be used as a working fluid.

The hydrostatic bearing features were machined into a nominally 2.54 mm thick sheet of adhesive-backed ultra-high molecular weight high density polyethylene. An aluminum housing was machined out of a solid block of aluminum to prevent any warping due to residual stresses as occurred in initial efforts to use a tube cut in half axially. A shaft was machined to provide 0.13 mm nominal gap. The aluminum housing, plastic and shaft were heated to 130° C. in a furnace with a 127 μm thick sheet of shim stock between the shaft and the plastic to thermally form the plastic to the proper gap, where the bearing gap would ideally be the thickness of the shim stock.

This process reduced the stresses in the plastic and reduces issues with delamination of the plastic. A test setup was built for the bearing which includes a dedicated impeller pump, filter, flow meter, digital pressure readout, and ball valves for flow control in the fluid circuit. Air bearings are used to constrain the shaft axially. An Admet 5604 single column universal testing machine and 300 lb load cell are used for applying load to the shaft. The 5604 is driven by Admet's MTestQuattro software. Lion Precision U3B eddy current probes driven by an ECL202 driver measure the shaft location. The MTestQuattro system records readings from the load cell, eddy current probes, and pressure gauge. FIG. 3 shows the plastic glued into the aluminum housing 14 sitting in the test rig.

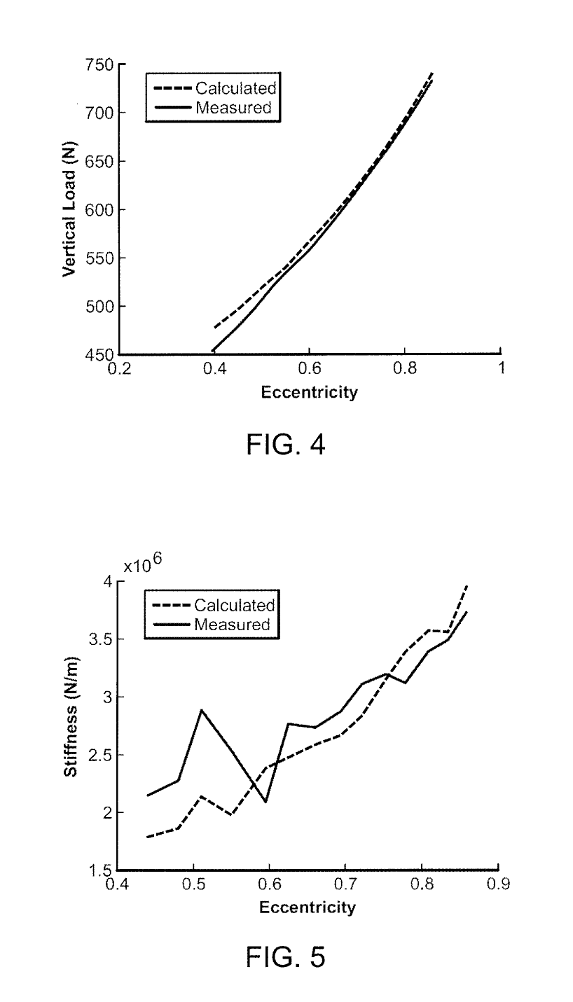

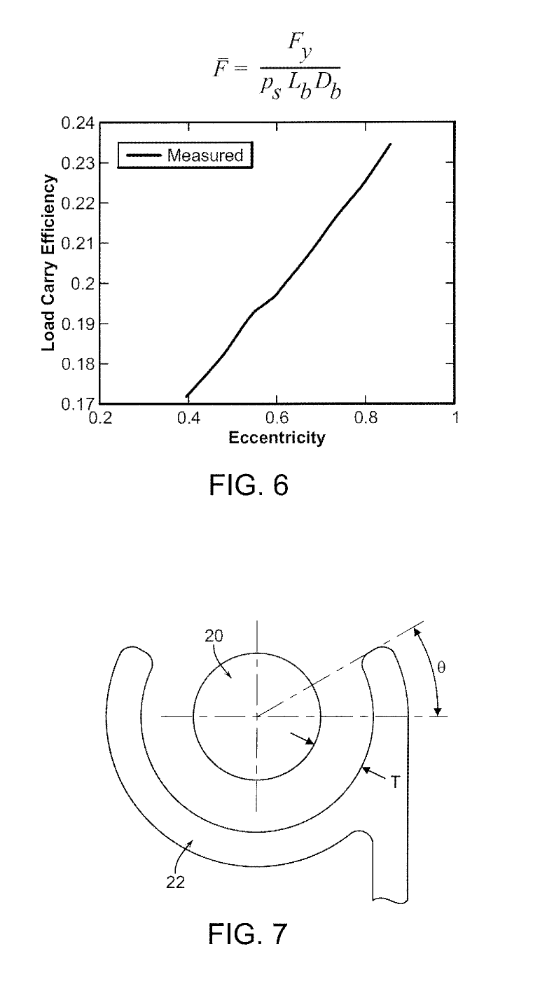

The results from the bearing design are promising. FIG. 4 shows the calculated and measured vertical load that the bearing supports. The calculated values come from a Matlab script solving the hydraulic resistance network model for the bearing. FIG. 5 shows the stiffness of the bearing, where the stiffness is defined as the change in force divided by the change in bearing gap, k=ΔF/Δh. These two data sets demonstrate that the design is deterministic and that the hydraulic resistance model reliably predicts the performance of the bearing. FIG. 6 shows the measured efficiency of the model, where the efficiency is the load divided by the supply pressure multiplied by the projected area of the bearing, F̅=F/PDL, where D and L are the bearing diameter and length, respectively. At 75% gap closure, the bearing has a 23% efficiency.

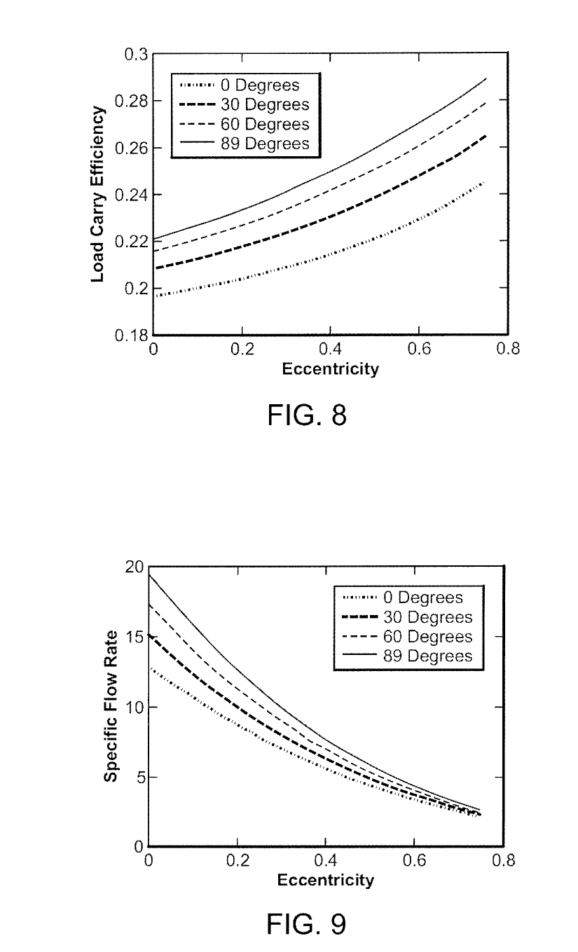

Analysis was conducted to determine the effect of wrapping 22 the groove further around the inlet holes 20. FIG. 7 shows and example of increasing the amount the compensator wraps around the inlet as well as the angle used to measure the additional length. The grooves were changed symmetrically, and the angle, θ, is half the total amount of additional arc. FIG. 8 shows the results of an analysis done for the same bearing with different additional angles of additional groove wrapping around the inlet. The curves shown are for the bearing operating at 15 psi inlet pressure. As the compensator wraps further around the inlet, the amount of vertical load increases. However, the additional load capacity comes at the cost of additional flow rate. FIG. 9 shows how the specific flow rate increases with increasing angle of additional wrap. Specific flow rate is defined as

$$\overline{Q} = Q / ( \frac{P π {Dh}_{o}^{3}}{12 μL} ) ,$$

where Q is the total flow rate and hₒ is the bearing gap when the axes of the bearing and shaft are aligned.

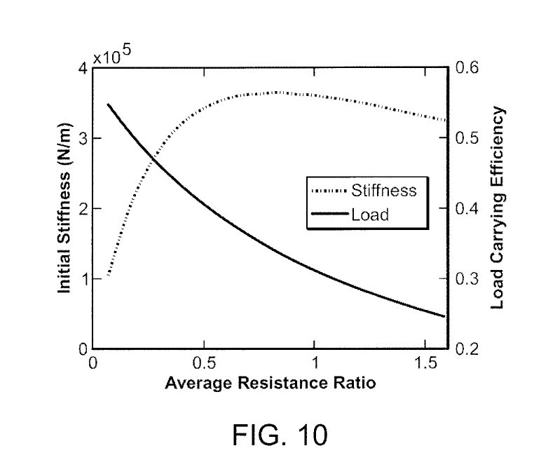

Another analysis was done to examine the effect of the compensator land thickness, T, shown in FIG. 7. This land can be adjusted to change the fluid resistance of the compensator and thus the resistance ratio, which is defined as the ratio of the resistance of the inlet to the resistance of the outlet. FIG. 10 shows the results. The abscissa is the resistance ratio at an eccentricity of 0.01 averaged over the three pockets. The initial stiffness is calculated as a change in vertical force for a change in eccentricity of 0.01 to 0.02. The reported load carrying efficiency is calculated at 75% gap closure. As can be seen, varying the resistance ratio trades load carrying efficiency for stiffness, and both cannot be optimized simultaneously by means of the resistance ratio alone.

This work demonstrates the deterministic design theory behind a hydrostatic bearing covering less than 180° of the shaft surface. This paper evaluates just one half of a bearing to support a horizontal heavy shaft. This bearing design facilitates installation and repair of hydrostatic bearings in support of large shafts. The ultimate goal is to be able to produce a low cost bearing which runs hydrostatically at low shaft speeds and hydrodynamically at high shaft speeds to reduce operating cost by allowing pumping power to be reduced.

Although the present invention has been shown and described with respect to several preferred embodiments thereof, various changes, omissions and additions to the form and detail thereof, may be made therein, without departing from the spirit and scope of the invention.

What is claimed is:

1. A hydrostatic bearing comprising:
a plurality of bearing pads that form loading carrying areas; and
a plurality of compensators that are coupled to the bearing pads, each compensator includes a recessed region forming a partial arc that partially surrounds an inlet hole, the bearing pads and compensators form self-compensating features positioned on the same side of a shaft that is conducive to hydrodynamic operations.

2. The hydrostatic bearing of claim 1, wherein cover an arc less than 180°

3. The hydrostatic bearing of claim 1, wherein the shaft comprises a diameter of 100 mm and has three pocket regions for tilt stiffness.

4. The hydrostatic bearing of claim 3, wherein the dimensions of the self-compensating feature are sized so that the hydrostatic bearing length is roughly twice the diameter.

5. The hydrostatic bearing of claim 1, wherein the bearing pads are recess areas surrounded by raised lands.

6. The hydrostatic bearing of claim 1, wherein the compensators comprise grooved recessed areas surrounded by raised lands.

7. The hydrostatic bearing of claim 1, wherein the surface of the shaft is less than 180° covered by the hydrostatic bearing.

8. The hydrostatic bearing of claim 6, wherein the depth of the groove recessed areas are selected to be 10 times deeper than the bearing gap of the hydrostatic bearing.
